(19) United States
(12) Patent Application Publication
(10) Pub. No.: US 2020/0081422 A1
(43) Pub. Date: Mar. 12, 2020

(54) METHODS AND SYSTEMS FOR PREDICTING HEALTH OF PRODUCTS IN A MANUFACTURING PROCESS

(71) Applicant: SAMSUNG ELECTRONICS CO., LTD., SUWON-SI (KR)

(72) Inventors: SHASHANK SHRIKANT AGASHE, Bangalore (IN); Sameera Bharadwaja Hayavadana, Bangalore (IN); Byeong Eon Lee, Yongin-si (KR); Harshit Pande, Bangalore (IN); Yune Tech Han, Hwaseong-si (KR)

(21) Appl. No.: 16/251,924

(22) Filed: Jan. 18, 2019

(30) Foreign Application Priority Data
Sep. 12, 2018 (IN) 201841034297

(51) Int. Cl. G05B 19/418; G05B 23/02

(52) U.S. Cl. CPC G05B 19/41875; G05B 23/0229; G05B 19/41885

(57) ABSTRACT

The embodiments herein disclose methods and systems for predicting health of products in a manufacturing process. A method includes determining at least one of a dynamic data and a static data of at least one product from a manufacturing process steps. Further, the method includes determining and filtering at least one of a gradual change, an abrupt change and a similar data present in the at least one of the dynamic data and the static data. Further, the method includes converting the filtered at least one of the dynamic data and the static data of the at least one product into a common data format. The common data format can be stored in a common hyperspace. Further, the method includes predicting a health of the at least one product based on the common data format and the at least one product historical health information received from an apriori computer.

### CROSS-REFERENCE TO RELATED APPLICATION

This application claims priority under 35 U.S.C. § 119 to Indian Patent Application No. 201841034297 filed on Sep. 12, 2018, the disclosure of which is incorporated by reference herein in its entirety.

### TECHNICAL FIELD

The present disclosure relates to the field of product manufacturing, and more particularly, to predicting health of products and a manufacturing equipment.

### DISCUSSION OF THE RELATED ART

Conventional product health predicting mechanisms suffer from a long standing problem relating to a lack of ability to predict the physical parameters of the product. For example, in case of a wafer, the conventional product health predicting mechanisms are unable to predict physical parameters of the wafer such as critical dimension, thickness, overlay, etch depth etc., across the whole wafer using multi-modal data such as process conditions (e.g. sensor time series), wafer images (e.g. overlay plots, CD/etch rate/thickness map), text inputs (e.g. deviation report written by Fab engineers) and audio/video signals (e.g. the vibration noise of vacuum pumps).

Further, the conventional product health predicting mechanisms are unable to recommend optimum recipe parameters at a granularity that causes a desired effect on the physical parameters across the whole wafer map. The conventional mechanisms are limited to analyzing the wafer quality data and then recommending recipe parameters and set points at sub-step level.

The conventional mechanisms are unable to handle the above mentioned problems due to the following challenges:

First, fabrication data exists in multiple data modes/formats as mentioned above. Most of the machine learning methods employed in the conventional techniques combines either one or a few of the data formats for analysis, leaving out the other data contained in the rest of the data formats.

The equipment used for processing the wafers changes its condition over time, which can result in a gradual drift in the sensor data. Additionally, when the equipment parts are repaired or replaced, there can be an abrupt shift in the sensor data. Due to these characteristics, it's difficult to predict the wafer quality.

Further, the wafers may take multiple paths to reach process steps. Thus, the distribution of incoming wafer quality can be wide. When measurement data prior to an examined process doesn't exist, the task of post prediction can be challenging.

Since the conventional mechanisms do not combine wafer image and recipe information for learning their correlation, an automated adjustment of the wafer process recipe is limited to rules based on domain knowledge and doesn't give recommendations at the granularity of single sample point.

### SUMMARY

Embodiments described herein disclose methods and systems for predicting health of products in a manufacturing process. A described method includes determining a dynamic data and a static data of product(s) from a manufacturing process steps. Further, the method includes determining and filtering at least one of a gradual change, an abrupt change and a similar data present in the dynamic data and the static data of the product(s). Further, the method includes converting the filtered dynamic data and the static data of the product(s) into a common data format. Further, the method includes predicting health of the product(s) based on the common data format and a historical health information of the product(s) received from an apriori computer.

A described method includes receiving at least one of a dynamic data and a static data of at least one product as an input data from a manufacturing process steps. The at least one of the dynamic data and the static data of the at least one product includes at least one of a time series information, event series information, image data, audio information and video information of the at least one product. Further, the method includes determining at least one of a gradual change, an abrupt change and a similar data present in the at least one of the dynamic data and the static data of the at least one product. Further, the method includes filtering the determined at least one of the gradual change, the abrupt change and the similar data present in the at least one of the dynamic data and the static data of the at least one product. Further, the method includes converting the filtered at least one of the dynamic data and the static data of the at least one product into a common data format, wherein the common data format stored in a common hyperspace. Further, the method includes predicting a health of the at least one product based on the common data format and a historical health information of the at least one product received from an apriori computer. Further, the method includes predicting a health of an equipment manufacturing the at least one product based on the common data format and the historical health information of the at least one product received from an apriori computer. Further, the method includes predicting an optimum process parameter to obtain desired health of the at least one product based on the common data format and the historical health information of the at least one product received from an apriori computer. Further, the method includes displaying the predicted health of the at least one product and the equipment manufacturing the at least one product using at least one of a time series, event series, image, audio and video formats.

Accordingly the embodiments herein provide an electronic device for predicting health of products. The electronic device may comprise a modal conditioner unit configured to receive at least one of a dynamic data and a static data of at least one product as an input data from a manufacturing process steps. The at least one of the dynamic data and the static data of the at least one product includes at least one of a time series information, event series information, image data, audio information and video information of the at least one product. Further, the modal conditioner unit may be configured to determine at least one of a gradual change, an abrupt change and a similar data present in the at least one of the dynamic data and the static data of the at least one product. Further, the modal conditioner unit may be configured to filter the determined at least one of the gradual change, the abrupt change and the similar data present in the at least one of the dynamic data and the static data of the at least one product.

Further, the electronic device may comprise a multi format data encoder unit configured to convert the filtered at least one of the dynamic data and the static data of the at least one product into a common data format, wherein the common data forma stored in a common hyperspace. Further, the electronic device may comprise a transfer function unit configured to predict a health of the at least one product based on the common data format and a historical health information of the at least one product received from an apriori computer. Further, the transfer function unit may be configured to predict a health of an equipment manufacturing the at least one product based on the common data format and the historical health information of the at least one product received from an apriori computer. Further, the transfer function unit may be configured to predict an optimum process parameter to obtain desired health of the at least one product based on the common data format and the historical health information of the at least one product received from an apriori computer. Further, the electronic device may comprise a display unit configured to display the predicted health of the at least one product and the equipment manufacturing the at least one product using at least one of a time series, event series, image, audio and video formats.

According to embodiments of the present disclosure, the electronic device may receive first data (i.e., dynamic data) related to sensors monitoring equipment for manufacturing the products, receiving second data (i.e., static data) related to the health of the products, where the second data is independent of the sensors, identifying patterns in the first data and the second data, where the identified patterns relate to abrupt changes, gradual changes, or similarities to previous data, convert the first data and the second data into a common format, and predict the health of the products based at least in part on the converted first data, the converted second data, and the identified patterns.

In some cases, the electronic device may divide the first data according to a location on a manufacturing line, wherein the patterns are identified based on the divided first data. In some cases, the electronic device may divide the first data according to a changes in the equipment, wherein the patterns are identified based on the divided first data.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 is block diagram illustrating various units of an electronic device for predicting quality/health of a product in a manufacturing process, according to embodiments as disclosed herein;

FIG. 2 is a block diagram illustrating a method for predicting quality/health of a product in a manufacturing process, according to embodiments as disclosed herein;

FIG. 3 is a flow diagram illustrating a method for predicting quality/health of a product in a manufacturing process, according to embodiments as disclosed herein; and

FIG. 4 is an example block diagram illustrating a method for predicting quality/health of a wafer in a manufacturing process, according to embodiments as disclosed herein.

### DETAILED DESCRIPTION OF THE EMBODIMENTS

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

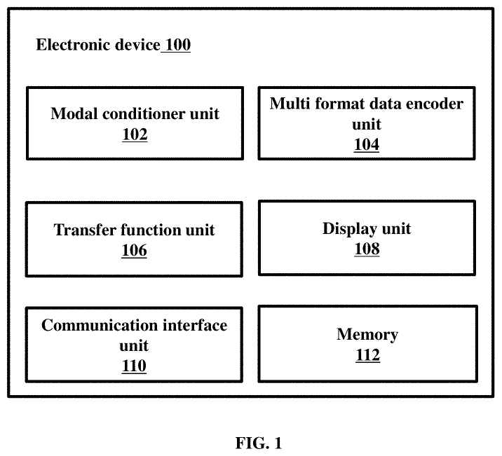

The embodiments herein achieve methods and systems for predicting health of products in a manufacturing process. A described method includes receiving at least one of a dynamic data and a static data of at least one product from a manufacturing process steps, wherein the at least one of the dynamic data and the static data of the at least one product includes at least one of a time series information, event series information, image data, audio information and video information of the at least one product. Further, the method includes determining at least one of a gradual change, an abrupt change and a similar data present in the at least one of the dynamic data and the static data of the at least one product. Further, the method includes filtering the determined at least one of the gradual change, the abrupt change and the similar data present in the at least one of the dynamic data and the static data of the at least one product. Further, the method includes converting the filtered at least one of the dynamic data and the static data of the at least one product into a common data format. The common data format can be stored in a common hyperspace. Further, the method includes predicting a health of the at least one product based on the common data format and a historical health information of the at least one product received from an apriori computer. Further, the method includes predicting a health of an equipment manufacturing the at least one product based on the common data format and the historical health information of the at least one product received from the apriori computer. Further, the method includes predicting an optimum process parameter to obtain desired health of the at least one product based on the common data format and the historical health information of the at least one product received from an apriori computer. Further, the method includes displaying the predicted health of the at least one product and the equipment using at least one of a time series, event series, image, audio and video formats. Referring now to the drawings, and more particularly to FIGS. 1 through 4, where similar reference characters denote corresponding features consistently throughout the figures, there are shown example embodiments.

FIG. 1 is block diagram illustrating various units of an electronic device 100 for predicting quality/health of a product in a manufacturing process, according to embodiments as disclosed herein.

In an embodiment, the electronic device 100 can be at least one of, but is not restricted to, a mobile phone, a smartphone, tablet, a phablet, a personal digital assistant (PDA), a laptop, a computer, a wearable computing device, an Internet of Things (IoT) device, a computing device and any other electronic device which has the capability of handling multiple data formats for predicting the health of the products.

The electronic device 100 includes a modal conditioner unit 102, a multi format data encoder unit 104, a transfer function unit 106, a display unit 108, a communication interface unit 110 and a memory 112. The modal conditioner unit 102 can be configured to receive at least one of a dynamic data and a static data of at least one product as an input from a manufacturing process steps, wherein at least one of the dynamic data and the static data of the at least one product includes at least one of a time series information, event series information, image data, audio information and video information of the at least one product. The at least one product can be at least one of, but is not restricted to a wafer, a bottle, automotive parts, food products, consumer electronics or any other product that goes through multiple process steps with the intention of replicating exact process parameters and their effects, which covers both micro and macro items/products.

In an embodiment, the dynamic data can be a data related to the at least one product going through the manufacturing process steps. The dynamic data can be received from sensors present on the equipment for manufacturing the at least one product. The nature of the dynamic data changes, for example, if something fails in the product manufacturing process (e.g., a failure based on some valve malfunctioning). Further, if some failure has occurred to some other product in the manufacturing process on some other day, the root cause for that failure can be something else. The dynamic data can be non-stationary, because the root cause or the predictive behavior of the product cannot always be the same. In an embodiment, the static data can be for example, long term trends of the at least one product and the multiple process steps involved in manufacturing the at least once product. However, the static data may not be specific to the particular product which is moving through the manufacturing process.

Further, the modal conditioner unit 102 can be configured to determine at least one of a gradual change, an abrupt change and a similar data (i.e., data similar to past data) present in the at least one of the dynamic data and the static data of the at least one product. In an embodiment, the modal conditioner unit 102 can be configured to determine non-stationary behavior of the dynamic data of the at least one product. For example, the dynamic data may be subject to trends, or it can have different root cause failures over time (for example, annual seasonality, monthly seasonality, or the like), that can be removed or addressed by the modal conditioner unit 102.

In an embodiment, the modal conditioner unit 102 can be configured to detect abrupt changes (e.g., an unintentional change that takes place in the manufacturing process of the at least one product which may be abrupt). For example, the abrupt change may relate to equipment which heats up a bottle to shape the bottle. Any component replacement in the equipment, for example, replacing a thermal couple for the equipment, may result in an abrupt change or offset.

In an embodiment, the modal conditioner unit 102 can be configured to identify similar data (for example, similar root cause failures that have happened in the past) present in the manufacturing process of the at least one product. The modal conditioner unit 102 can be configured to identify clusters which have a similar root cause or tendency. Further, the modal conditioner unit 102 can be configured to filter the determined at least one of the gradual change, the abrupt change and the similar data present in the at least one of the dynamic data and the static data of the at least one product.

The multi format data encoder unit 104 can be configured to convert the filtered at least one of the dynamic data and the static data of the at least one product into a common data format (for example, a numbering format). The common data format can be stored in a common hyperspace. Once the multi format data encoder unit 104 converts the input data into the numbering format, it can use an apriori computer input (i.e., historical product health data) to condition the common hyperspace.

The transfer function unit 106 can be configured to predict a health of the at least one product based on the common data format and historical health information of the at least one product received from the apriori computer. Further, the transfer function unit 106 can be configured to predict a health of equipment manufacturing the at least one product based on the common data format and the historical health information of the at least one product received from the apriori computer. Further, the transfer function unit 106 can be configured to predict an optimum process parameter to obtain desired health of the at least one product based on the common data format and the historical health information of the at least one product received from the apriori computer. The display unit 108 can be configured to display the predicted health of the at least one product and the equipment manufacturing the at least one product using at least one of a time series, event series, image, audio and video formats. The communication interface unit 110 can be configured to establish communication between the electronic device 100 and the equipment manufacturing the at least one product.

The memory 112 can be configured to store the received input data from the manufacturing process steps, which includes at least one of static and dynamic data. The memory 112 may include one or more computer-readable storage media. The memory 112 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 112 may, in some examples, be considered a non-transitory storage medium. The term “non-transitory” may indicate that the storage medium is not embodied in a carrier wave or a propagated signal. However, the term “non-transitory” should not be interpreted to mean that the memory 112 is non-movable. In some examples, the memory 112 can be configured to store larger amounts of information than the memory. In certain examples, a non-transitory storage medium may store data that can, over time, change (e.g., in Random Access Memory (RAM) or cache).

Thus, the electronic device 100 may receive first data (i.e., dynamic data) related to sensors monitoring equipment for manufacturing the products, receiving second data (i.e., static data) related to the health of the products, where the second data is independent of the sensors, identifying patterns in the first data and the second data, where the identified patterns relate to abrupt changes, gradual changes, or similarities to previous data, convert the first data and the second data into a common format, and predict the health of the products based at least in part on the converted first data, the converted second data, and the identified patterns.

In some cases, the electronic device 100 may divide the first data according to a location on a manufacturing line, wherein the patterns are identified based on the divided first data. In some cases, the electronic device 100 may divide the first data according to a changes in the equipment, wherein the patterns are identified based on the divided first data.

FIG. 1 shows exemplary units of the electronic device 100, but it is to be understood that other embodiments are not limited thereon. In other embodiments, the electronic device 100 may include fewer or more units. Further, the labels or names of the units are used only for illustrative purpose and do not limit the scope of the embodiments herein. One or more units can be combined to perform the same or substantially similar functions in the electronic device 100.

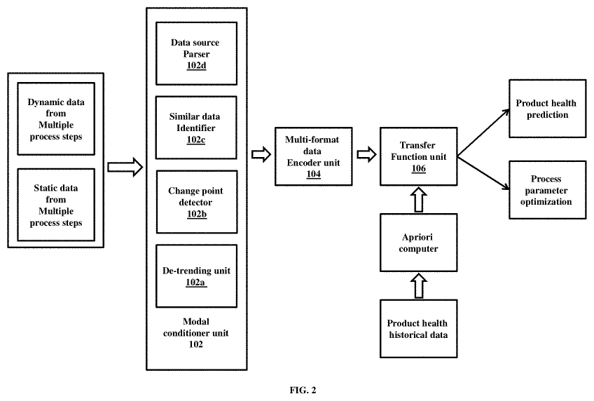

FIG. 2 is a block diagram illustrating a method for predicting quality/health of a product in a manufacturing process, according to embodiments as disclosed herein.

The embodiments herein provide a method and electronic device 100 for predicting quality/health of the product in the manufacturing process. The electronic device 100 comprises the modal conditioner unit 102, which may be configured to receive the dynamic data and the static data of product(s) as an input from the manufacturing process steps. The dynamic data and the static data can be of different data formats. For example, the dynamic data and the static data includes at least one of but not limited to a time series information, event series information, image data, audio information and video information. The dynamic data can be the input data related to the product(s) going through the manufacturing process steps. The dynamic data can be received from the sensors present on the equipment manufacturing the product(s). The nature of the dynamic data changes due to different root causes in the manufacturing process. The dynamic data can be non-stationary, due to the root cause or the predictive behavior of the product. In an embodiment, the static data can be for example, long term trends of the at least one product and the multiple process steps involved in manufacturing the at least once product.

The modal conditioner unit 102 may comprise a de-trending unit 102a configured to determine the gradual changes present in the at least one of the dynamic data and the static data of the product(s). In an embodiment, the de-trending unit 102a can be configured to detect abrupt changes i.e., some unintentional changes that takes place in the manufacturing process of the product(s). Further, the modal conditioner unit 102 may comprise a change point detector 102b configured to determine the abrupt changes present in the at least one of the dynamic data and the static data of the product(s).

Further, the modal conditioner unit 102 may comprise similar data identifier 102c configured to determine the similar data (i.e., patterns matching previous data) present in the at least one of the dynamic data and the static data of the product(s).

In an embodiment, the similar data identifier 102c can be configured to identify similar data (for example, similar root cause failures that happened in the past) present in the manufacturing process of the at least one product. For example, the similar data identifier 102c can identify clusters which have similar root cause or similar tendencies.

Further, the modal conditioner unit 102 can be configured to filter the determined at least one of the gradual change, the abrupt change and the similar data present in the at least one of the dynamic data and the static data of the at least one product. Further, the modal conditioner unit 102 comprises a data source parser 102d. The data source parser 102d identifies a raw format of the at least one of the dynamic data and the static data of the product(s) coming from various sources of the manufacturing process, to convert the raw format of the data to into a common data format. For example, the data source parser 102d identifies files or data streams from the equipment's or any other communication interface between the equipment's and the manufacturing process eco-system, to convert the raw format of the data into the common data format (for example, numerical vector or matrix; categorical sequence or set or the like).

The electronic device 100 may further comprise a multi format data encoder unit 104, which can be configured to convert the filtered dynamic data and static data of the product(s) into a common data format. The common data format can be stored in the common hyperspace. Once the multi format data encoder unit 104 converts the input data into the numbering format. The multi format data encoder unit 104 can use an apriori computer input (i.e., product health historical data) to condition the common hyperspace.

The electronic device 100 may further comprise the transfer function unit 106, which may be configured to predict the health of the product(s) based on the common data format and the historical health information of the product(s) received from the apriori computer. The transfer function unit 106 can be configured to predict the optimum process parameters to obtain a desired health of the at least one product based on the common data format and the historical health information of the product(s) received from the apriori computer. The display unit 108 can be configured to display the predicted health of the product(s) and the equipment manufacturing the product(s) using at least one of a time series, event series, image, audio and video formats.

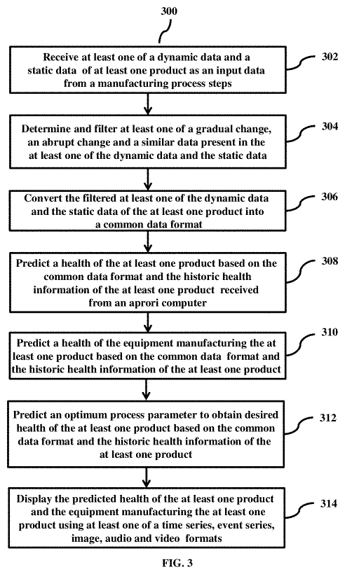

FIG. 3 is a flow diagram illustrating a method for predicting quality/health of the product in the manufacturing process, according to embodiments as disclosed herein.

At step 302, the method includes receiving at least one of a dynamic data and a static data of at least one product as the input data from a set of manufacturing process steps. The method allows the modal conditioner unit 102 to receive at least one of a dynamic data and a static data of at least one product as the input data from the manufacturing process steps. In some examples, at least one of the dynamic data and the static data of at least one product includes at least one of a time series information, event series information, image data, audio information and video information of the at least one product.

At step 304, the method includes determining and filtering at least one of a gradual change, an abrupt change and a similar data present in the at least one of the dynamic data and the static data of the at least one product. The method allows the modal conditioner unit 102 to determine and filter at least one of the gradual change, the abrupt change and the similar data present in the at least one of the dynamic data and the static data of the at least one product.

At step 306, the method includes converting the filtered at least one of the dynamic data and the static data of the at least one product into a common data format. The method allows the multi format data encoder unit 104 to convert at least one of the dynamic data and the static data of the at least one product into the common data format. The common data format may be stored in a common hyperspace.

At step 308, the method includes predicting the health of the at least one product based on the common data format and the historic health information of the at least one product received from the apriori computer. The method allows the transfer functional unit 106 to predict the health of the at least one product based on the common data format and the historic health information of the at least one product received from the apriori computer.

At step 310, the method includes predicting a health of the equipment manufacturing the at least one product based on the common data format and the historic health information of the at least one product received from the apriori computer. The method allows the transfer functional unit 106 to predict the health of the equipment manufacturing the at least one product based on the common data format and the historic health information of the at least one product received from the apriori computer.

At step 312, the method includes predicting an optimum process parameter to obtain a desired health of the at least one product based on the common data format and the historic health information of the at least one product received from the apriori computer. The method allows the transfer functional unit 106 to predict the optimum process parameter to obtain desired health of the at least one product based on the common data format and the historic health information of the at least one product received from the apriori computer.

At step 314, the method includes displaying the predicted health of the at least one product and the equipment manufacturing the at least one product using at least one of a time series, event series, image, audio and video formats. The method allows the display unit 108 to display the predicted health of the at least one product and the equipment manufacturing the at least one product using at least one of a time series, event series, image, audio and video formats.

The various actions, acts, blocks, steps, or the like in the method and the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

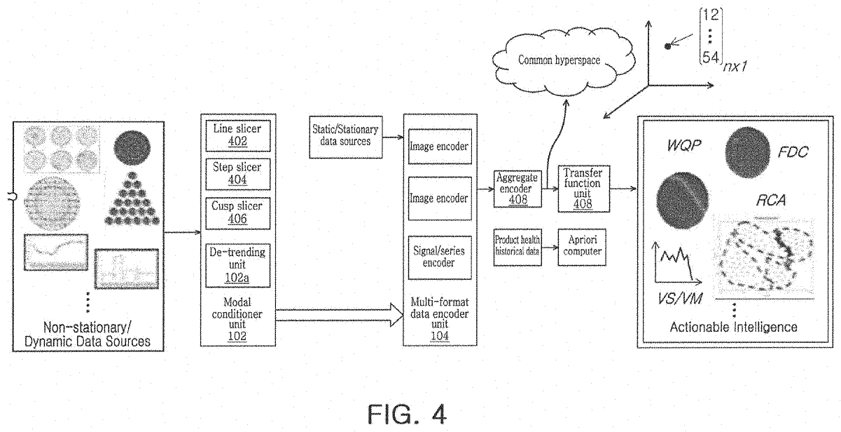

FIG. 4 is an example block diagram illustrating a method for predicting quality/health of a wafer in a manufacturing process, according to embodiments as disclosed herein.

The at least one of the dynamic data and the static data of at least one product from multi-modal dynamic/non-stationary sources are fed into a line slicer 402, which can be configured to segregate at least one of the dynamic data and the static data based on locations or overall characteristics of the manufacturing process line. Further, a step slicer 404 can be configured to segregate the dynamic data and the static data based on maintenance events, which are one of the causes for data dynamicity. Further, a cusp slicer 406 and de-trending unit 102a can be configured to slice the dynamic data and the static data based on alarm events and other soft trend drivers, such as equipment ageing or the like, to make the dynamic data and the static data stationary.

This data, along with stationary data coming from maintenance notes of engineers or the like, can be fed into multi-format data encoder unit 104 which may convert the raw data into the common data format. For example, feature/attribute list/vector format using any of known signal processing, natural language or image processing, machine/deep learning techniques based on a data mode. The common data format can be stored in the common hyperspace. The features/attributes from each data mode is aggregated using aggregate encoders 408. Combining the data fetched from the aggregate encoders 408 along with a knowledge obtained from the apriori computer and the transfer function can be accomplished using any known machine/deep learning or rule based techniques. Further, the transfer function can be learned/trained based on the application area.

The embodiments disclosed herein can be implemented through at least one software program running on at least one hardware device and performing network management functions to control the elements. The elements shown in FIG. 1 and FIG. 2 can be at least one of a hardware device, or a combination of hardware device and software module.

The foregoing description of the specific embodiments will so fully reveal the general nature of the embodiments herein that others can, by applying current knowledge, readily modify and/or adapt such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

We claim:

1. A method for predicting health of products by an electronic device, the method comprising:
receiving, by a modal conditioner unit, at least one of a dynamic data and a static data of at least one product as an input data from a manufacturing process step, wherein the at least one of the dynamic data and the static data of the at least one product includes at least one of time series information, event series information, image data, audio information and video information of the at least one product;
determining, by the modal conditioner unit, at least one of a gradual change, an abrupt change and a similar data present in the at least one of the dynamic data and the static data of the at least one product;
filtering, by the modal conditioner unit, the determined at least one of the gradual change, the abrupt change and the similar data present in the at least one of the dynamic data and the static data of the at least one product;
converting, by a multi format data encoder unit, the filtered at least one of the dynamic data and the static data of the at least one product into a common data format, wherein the common data format is stored in a common hyperspace; and
predicting, by a transfer function unit, a health of the at least one product based on the common data format and a historical health information of the at least one product received from an apriori computer.

2. The method of claim 1, wherein the method further includes predicting, by the transfer function unit, a health of an equipment manufacturing the at least one product based on the common data format and the historical health information of the at least one product received from an apriori computer.

3. The method of claim 1, wherein the method further includes predicting, by the transfer function unit, an optimum process parameter to obtain desired health of the at least one product based on the common data format and the historical health information of the at least one product received from an apriori computer.

4. The method of claim 1, wherein the method further includes displaying, by a display unit, predicted health of the at least one product and an equipment manufacturing the at least one product using at least one of a time series, event series, image, audio and video formats.

5. An electronic device for predicting health of products, the electronic device comprising:
a modal conditioner unit configured to:
receive at least one of a dynamic data and a static data of at least one product as an input data from a manufacturing process steps, wherein the at least one of the dynamic data and the static data of the at least one product includes at least one of a time series information, event series information, image data, audio information and video information of the at least one product,
determine at least one of a gradual change, an abrupt change and a similar data present in the at least one of the dynamic data and the static data of the at least one product, and
filter the determined at least one of the gradual change, the abrupt change and the similar data present in the at least one of the dynamic data and the static data of the at least one product;
a multi format data encoder unit configured to:
convert the filtered at least one of the dynamic data and the static data of the at least one product into a common data: format, wherein the common data formal is stored in a common hyperspace; and
a transfer function unit configured to:
predict a health of the at least one product based on the common data format and a historical health information of the at least one product received from an apriori computer.

6. The electronic device of claim 5, wherein the transfer function unit is further configured to predict a health of an equipment manufacturing the at least one product based on the common data format and the historical health information of the at least one product received from an apriori computer.

7. The electronic device of claim 5, wherein the transfer function unit is further configured to predict an optimum process parameter to obtain a desired health of the at least one product based on the common data format and the historical health information of the at least one product received from an apriori computer.

8. The electronic device of claim 5, wherein a display unit is configured to display predicted health of the at least one product and an equipment manufacturing the at least one product using at least one of a time series, an event series, an image, an audio format and a video format.

9. A method for predicting health of products by an electronic device, the method comprising:
receiving first data related to sensors monitoring equipment for manufacturing the products;
receiving second data related to the health of the products, wherein the second data is independent of the sensors;
identifying patterns in the first data and the second data, wherein the identified patterns relate to abrupt changes, gradual changes, or similarities to previous data;
converting the first data and the second data into a common format;
predicting the health of the products based at least in part on the converted first data, the converted second data, and the identified patterns.

10. The method of claim 9, further comprising:
dividing the first data according to a location on a manufacturing line, wherein the patterns are identified based on the divided first data.

11. The method of claim 9, further comprising:
dividing the first data according to a changes in the equipment, wherein the patterns are identified based on the divided first data.
